(19) United States
(12) Patent Application Publication
(10) Pub. No.: US 2018/0242524 A1
(43) Pub. Date: Aug. 30, 2018

(54) Device for Harvesting Stalk Material

(71) Applicant: Carl Geringhoff GmbH & Co. KG, Ahlen (DE)

(72) Inventors: Dietrich Baye, Westerkappeln (DE); Werner Hanskötter, Ennigerloh (DE); Reimer Tiessen, Oldenburg (DE); Andre Hemmesmann, Sassenberg (DE)

(21) Appl. No.: 15/758,347

(22) PCT Filed: Sep. 7, 2016
(86) PCT No.: PCT/EP2016/001507

§ 371 Date: Mar. 8, 2018

(30) Foreign Application Priority Data
Sep. 8, 2015 (DE) 10 2015 115 100.6

(51) Int. Cl. A01D 43/08; A01D 45/02; A01D 34/73; A01D 34/835

(52) U.S. Cl. CPC A01D 43/083; A01D 45/023; A01D 34/8355; A01D 34/73; A01D 45/025

(57) ABSTRACT

The invention relates to a device (2) for harvesting stalk material, comprising a feed region, a conveyor device (4), a picking device, and a device which is arranged on a plane below the picking device for cutting stalks and has at least one cutter that rotates in a circulating manner on a horizontal or at least approximately horizontal plane. The aim of the invention is to provide a device with which the vegetable structure of the stubble pieces are damaged in addition to being cut such that bacteria and moisture can more easily penetrate the interior of a stalk piece, in particular stubble standing on the field. This is achieved in that at least one impact element (22) is formed on the cutter (18) which rotates in a circulating manner, said impact element rising over the thickness of the cutter blade.

The present invention relates to a device for harvesting of stalk material, with a feed area, a conveyor device, a picking device and a device situated in a plane below the picking device for cutting of stalks, which has at least one rotating circulating cutter in a horizontal, or at least approximately horizontal, plane.

A generic device is known from the publication DE 203 03 819 U1. After a stalk of the stalk material, such as that of a corn plant, has, in this device, entered into the harvester, been pulled downwards by picking rollers and the targeted harvest material, such as ears from the corn plant, have been separated by the picking device from the cornstalk by picker plates, the remaining cornstalk is conveyed on downwards. A stalk pulled downward can be cut by fixed or rotating cutters, which are arranged in the area of the picking rollers. However, the stalk is cut off from the root system remaining in the ground, close to the ground, by a separate cutter device with at least one cutter that circulates in rotating fashion in a horizontal plane. The circulating cutter can additionally cut stalk pieces conveyed downwards by the picking rollers into shorter stalk pieces, which then are ejected onto the field. There the stalk pieces can decay. The ears of corn separated from the stalk are brought by the conveyor device to a threshing machine.

Since the cut surfaces of the stalk pieces are smoothly cut by the chaff cutter rotating in the horizontal plane, some time must pass until moisture and bacteria penetrate from without into the interior of a stalk piece and accelerate the decay process. This holds up the rotting process. This especially holds true for the stubble, which remains erect on the field. Often the still standing stubble is occupied by corn borers, whose caterpillars later cause considerable damage in corn stocks. To prevent this, the stubble needs to be more severely damaged.

Accordingly, it is the object of the present invention to create a device by which the stubble pieces, in addition to being cut, are so additionally damaged in their plant structure that bacteria and moisture can penetrate more easily into the interior of a stalk piece, especially into stubble standing in the field.

The object is attained for a generic device in that on the cutter rotating in circulating fashion, at least one impact element is configured which projects over the thickness of the cutter blade plate.

The cutter blade plate is the part of the cutter that carries the cutter blade. The cutter blade has a sharpened cutting edge that cuts through a plant at the interface in a section. The cutter blade plate per se is normally configured to be flat, in order that the blade can get through the cut material with as little force as possible. According to the invention, the blade additionally has one or more impact elements, which project over the thickness of the cutter blade plate and, when the blade rotates and a stalk is cut, hit the stubble body.

Upon impact, the outer layers of the stem axis are torn off, the attachment tissue of the stalk found beneath is defibered and spliced along the longitudinal axis of the stubble. By this means, considerable damage is inflicted on the stubble hit by the impact element. The smooth surface is destroyed. The surface is considerably enlarged by the destruction, through which bacteria and moisture can more easily penetrate into the stubble. The stubble decays more quickly thereby. The destructive effect on the stubble can be increased if multiple impact elements are configured on one blade.

The energy which needs to be expended to get the blade to rotate with the impact element or elements is increased by the impact elements in comparison to a traditional cutter. Since an impact element or elements can only be attached at separate places on a cutter, the additional energy expended does remain comparatively small. This especially holds true if the contour of the blade, apart from the impact element or elements, remains unchanged and favorable in energy terms.

The degree of destruction to the stubble attainable by the impact elements is so great, that depending on the harvested material, subsequent mulching can be dispensed with.

It is also advantageous that the stubble destruction be possible before stubble is rolled upon by the wheels of a harvester, and undamaged stubble is compressed into the ground. Such stubble would not be reachable for subsequent stubble treatment and could likely damage subsequent growth through insect infestation and fusarium fungi.

According to one embodiment of the invention, the cutter is driven at an r.p.m. of at least 1,500. With such an r.p.m of a rotating blade in a picker attachment, the result would be the impact element hitting the stubble at a very high impact speed. The energy acting on the stubble acts beyond the direct zone of contact of the impact element with the stubble and also damages neighboring stubble areas that the impact element itself does not directly reach. Due to this distant action of the impact element, the harvester no longer needs to be run so close to the ground that the stubble is cut to a length of 5 cm that is viewed as critical for corn borers. The harvester can rather run at a greater distance over the ground, through which damage by contact with foreign objects is reduced. At such a cutter r.p.m., an individual stalk of stubble is also impacted multiple times by an impact element, which additionally increased its degree of destruction.

According to one embodiment of the invention, the impact element has a cylindrical shape with a rounded tip. The cylindrical shape is ideal to absorb the impact energy into the material of the impact element and to distribute it, without the impact element itself being deformed or destroyed. Material ablation caused by usage on the side of the impact element pointing in the rotational direction is evenly distributed over the surface, so that the impact element has a long service life. The same holds true for the rounded form of the impact element tip.

According to one embodiment of the invention, the impact element is produced to be solid, made of a metallic material, with its outer layer additionally hardened. A metallic material such as steel has a high resistance capacity, resulting in long service life for the impact element. The service life is additionally increased by being produced as a solid. The hardening of the outer layer reduces material ablation through constant contact with the stubble.

According to one embodiment of the invention, the impact elements are situated only on the cutter side facing the ground. Since especially the stubble is to be damaged, with an arrangement of impact elements only on the side of the blade facing the ground, additional energy expenditure remains limited.

According to one embodiment of the invention, at least one impact element is situated in the center area of the blade width. This arrangement is advantageous, because in this area, the blade has its greatest strength.

According to one embodiment of the invention, the at least one impact element is screwed into the blade with a countersunk screw. The countersunk screw can be countersunk in the material of the blade, so that it does not project over the profile of the blade and can be abraded by material contact. The screw remains capable of functioning. If the first side of the blade should be worn, without large expense the impact element can be screwed onto the other side of the blade, so that even with a reversed blade when the blade rotational direction is not changed it is arranged with the second blade side in the turning direction on the underside of the blade.

According to one embodiment of the invention, beneath the picking plates at least two picking rollers are arranged along the picking gap, the minimum circumscribed circles of which overlap at least in some areas. In combination with the previously described impact elements, through the use of at least two picking rotors beneath the picking plates, there results a very efficient comminution system, which securely grips the cornstalks, conveys them downward, and not only comminutes and defibers the cut-off stalk parts, but also the upper ends of the stubble still standing in the field.

According to one embodiment of the invention, at intervals along the length of the picking gap, fixed or rotating blades are arranged, projecting into the minimum circumscribed circles of the picking rollers. The fixed or rotating blades cause a very effective comminution of the plant residues, which are drawn downward through the picking gap. By the use of fixed or rotating blades, which extend into the minimum circumscribed circles of the picking rotors, rapid forward speeds can be achieved during the harvest, without having to accept comminution performance that remains at the same good level, and simultaneous damage and defibering of the stubble ends standing on the ground.

Express attention is drawn to the fact that the previously explained embodiments of the invention can be per se, or also combined in any combination with each other with the subject of the main claim.

Further variations and configurations of the invention can be gleaned from the following subject-matter specification and the drawings.

The invention will now be explained in greater detail using the embodiment example. Shown are:

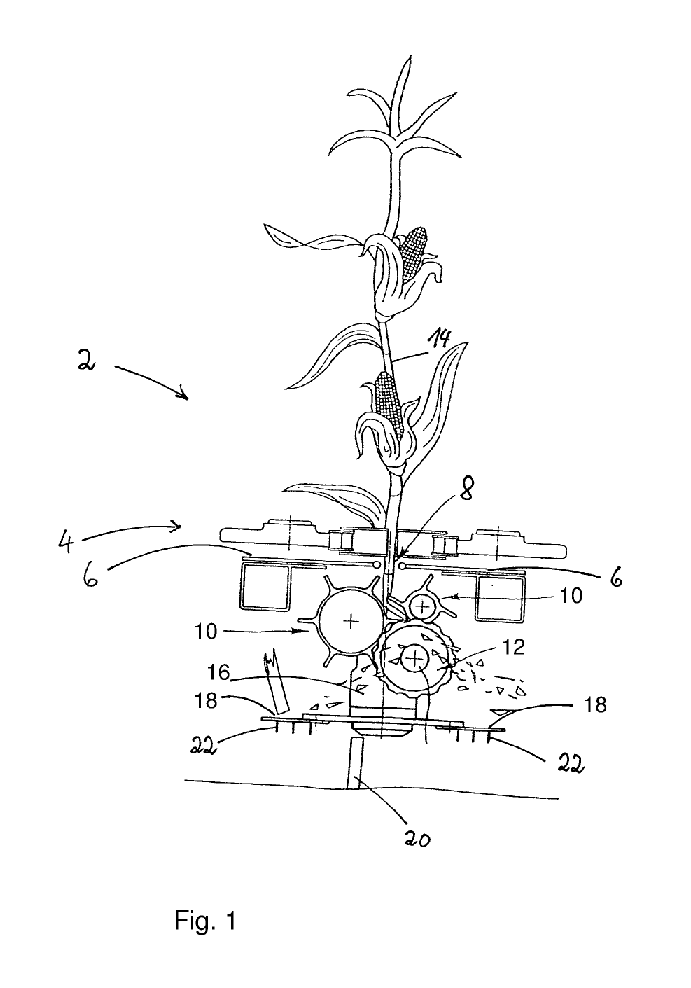

FIG. 1: a sectional view of a part of the harvester.

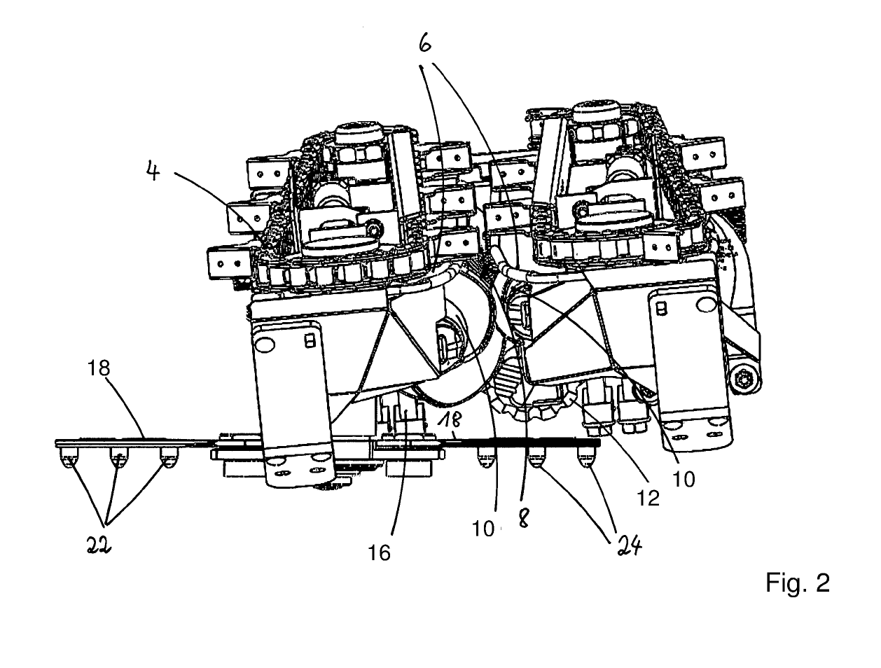

FIG. 2: a view of the assembly shown in FIG. 1 from in front

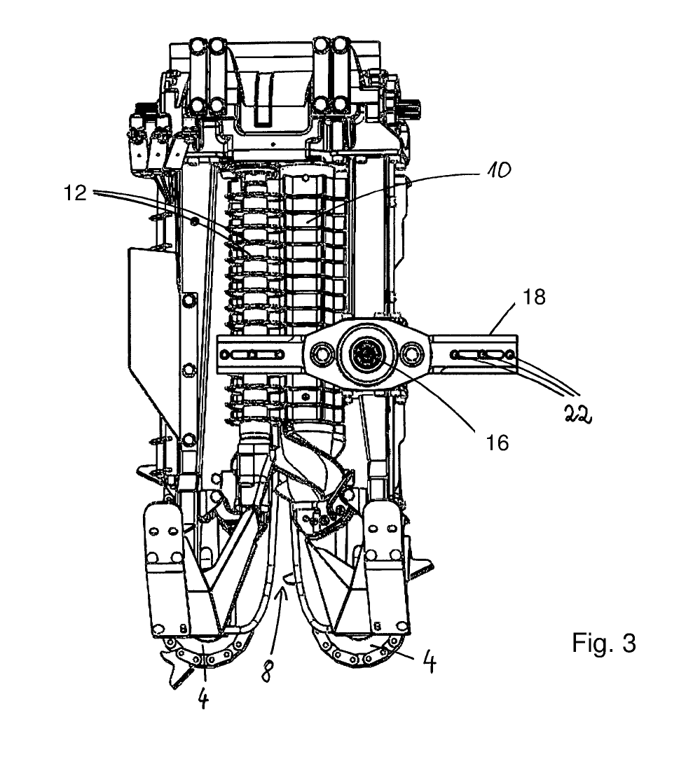

FIG. 3: a view of the underside of the assembly shown in FIG. 2 with the impact elements on the blades.

FIG. 1 shows a section of a device 2 for harvesting of stalk material. The device has available conveyor device 4, which in the embodiment consists of two opposite-placed conveyor chains, which on their outer side have a number of followers, by which ears of corn can be conveyed away from the cornstalk 14.

The ears of corn are separated from cornstalk 14 by a picking device which in the embodiment consists of two picking plates 6, which with their sides facing each other delimit a picking gap 8. Cornstalk 14 glides through the length of picking gap 8, while the picking rollers 10 situated below picking gap 8 grasp cornstalk 14 and pull it downwards. In the embodiment shown in FIG. 1, additionally one more blade 12 acts together with picking rollers 10 to comminute cornstalk 14 grasped by picking rollers 10.

Down into the area below picking rollers 10 extends a rotor shaft 16, on the lower end of which in the embodiment example two cutters 18 are attached. The two blades 18 rotate in a horizontal plane. With a rotary motion of the cutters 18, these separate the cornstalk from the stubble 20 remaining in the ground. The cutters 18 can with a rotational motion in addition also encounter parts of the cornstalk which fall down from picking rollers 10 and cutter blade 12.

In the embodiment example, the two cutters 18 are equipped with three additional impact elements 22. Impact elements 22 are on the underside of cutters 22 facing the ground. Impact elements 22 project over the cross-sectional surface of the two cutters 18, Thus they extend closer to the ground than the blades of the two cutters 18.

In FIG. 1, stubble 20 is shown in its still intact form. When stubble 20 has in fact had multiple encounters with impact elements 22, stubble 20 in its upper area has lost its cylindrical shape. It then is severely damaged and spliced.

FIG. 2 is a view of the assembly shown in FIG. 1, seen from the front. As can be gleaned from FIG. 2, impact element 22 has a cylindrical shape with a rounded tip 24. Impact element 22 consists of a metallic material and is designed to be solid.

From the enlarged view from below in FIG. 3 of the assembly shown in FIG. 2, it is perceived that the impact elements 22 are arranged in the center area of the width of cutter 26.

The embodiment example described above serves only for explanation of the invention. The invention is not limited to the embodiment example shown. It will pose no difficulties for one skilled in the art to alter the embodiment example in a way he finds suitable, to adapt it to a specific application.

What is claimed is:

1. A device (2) for harvesting of stalk material, with a feed area, a conveyor device (4), a picking device and a device arranged in a plane below the picking device for cutting of stalks, which has a circulating rotating blade in a horizontal plane or at least an approximately horizontal plane, wherein on the circulating rotating cutter (18) at least one impact element (22) is configured, which extends beyond the thickness of the cutter blade plate.

2. The device (2) of claim 1, wherein the cutter (18) is driven at an r.p.m. of at least 1500.

3. The device (2) of claim 1, wherein the impact element (22) has a cylindrical shape with a rounded tip.

4. The device (2) of claim 1, wherein the impact element (22) is configured as a solid, made from a metallic material, the outer layer of which additionally is hardened.

5. The device (2) of claim 1, wherein the impact elements (22) are arranged only on the cutter side facing the ground.

6. The device (2) of claim 1, wherein the at least one impact element (22) is arranged in the middle area of the cutter width.

7. The device (2) of claim 1, wherein the at least one impact element (22) is screwed into the cutter (18) with a countersunk screw.

8. The device (2) of claim 1, wherein beneath the picking plates (6) at least two picking rollers (10) are arranged along the picking gap (8), the minimum circumscribed circles of which overlap at least in some areas.

9. The device (2) of claim 8, wherein at intervals along the length of the picking gap (8), fixed or rotating blades (12) are arranged that extend into the minimum circumscribed circles of the picking rollers (10).
